(19) United States
(12) Patent Application Publication
(10) Pub. No.: US 2025/0305308 A1
(43) Pub. Date: Oct. 2, 2025

(54) SAFETY BARRIER

(71) Applicant: Donald R. McMullen, Orange, TX (US)

(72) Inventor: Donald R. McMullen, Orange, TX (US)

(73) Assignee: Donald R. McCullen, Orange, TX (US)

(21) Appl. No.: 19/096,349

(22) Filed: Mar. 31, 2025

Related U.S. Application Data
(60) Provisional application No. 63/573,071, filed on Apr. 2, 2024.

(51) Int. Cl. E04G 21/32; F16M 13/02

(52) U.S. Cl. CPC E04G 21/3233; F16M 13/022

(57) ABSTRACT

The invention relates to an improved safety barrier and components thereof. One component is an improved clamp for supporting one or more rails for cordoning off a protected area. The clamp may include one or more of an upper portion, a lower portion, an upper and a lower attachment for assisting in at least partially attaching the clamp to a support, a first and a second support arm attached between the upper portion and the lower portion, and a first and a second cross bar attached to the first support arm to support a rail. The support may include a leg having a bore there-through and a rod at least partially located in said bore, wherein the rod includes an anchor having an orientation at a first end and an alignment indicator indicative of said orientation.

### PRIORITY CLAIM

This application claims priority to provisional patent application Ser. No. 63/573,071 filed Apr. 2, 2024, which is fully incorporated herein by reference.

### TECHNICAL FIELD

Embodiments of the subject matter disclosed herein relate to an improved safety barrier and components thereof.

### DISCUSSION OF THE BACKGROUND

As those skilled in the art will appreciate, a raised flooring system is an elevated structural floor built above a solid substrate, typically a concrete slab, creating a hidden void underneath for various building services. This space is often used to house electrical wiring, HVAC ducts, plumbing, and communication cables, thereby allowing for easy access and reconfiguration when necessary. The panels used in raised floors are typically modular and rest on adjustable pedestals, enabling customization based on the required floor height and load capacity.

One of the primary reasons raised flooring systems are used is their ability to support flexible and dynamic environments, particularly in commercial and industrial settings. Modern office spaces, data centers, and control rooms frequently require adaptable infrastructure due to evolving technological needs. Raised floors simplify the process of upgrading or modifying cabling and utilities without requiring disruptive construction work, minimizing downtime and operational costs.

Data centers are among the most common applications for raised flooring systems because they provide an efficient way to manage cooling and cabling for high-performance computing equipment. The space beneath the raised floor allows for the distribution of chilled air, preventing overheating and improving overall energy efficiency. Additionally, raised floors in these environments help in organizing power cables and data lines, reducing clutter and mitigating risks associated with overheating and electromagnetic interference.

Office buildings often utilize raised flooring to facilitate the installation of power and data cables for workstations. The modular nature of these floors allows businesses to easily reconfigure layouts without extensive renovations. This flexibility is particularly valuable in co-working spaces, conference rooms, and open-plan offices where tenant needs may change over time. Additionally, the ability to house utilities beneath the floor eliminates the need for excessive wall-mounted outlets and cable management systems.

In industrial and manufacturing environments, raised floors are used to create clean and controlled spaces where dust and debris must be minimized. By placing ventilation and air filtration systems within the underfloor space, these floors help maintain optimal air quality and prevent contamination. Industries such as pharmaceuticals, electronics manufacturing, and laboratories benefit from this setup, as it supports stringent cleanliness requirements while allowing for efficient airflow management.

In financial institutions such as banks and trading floors, raised flooring systems help accommodate the high density of cables required for computer systems, communication devices, and security equipment. These environments demand both organization and accessibility to ensure smooth operations. The raised floor also aids in integrating underfloor cooling solutions, which are crucial for maintaining the performance of high-speed servers and electronic devices.

Museums and exhibition halls sometimes implement raised flooring to allow for the discreet routing of lighting, audiovisual equipment, and security systems. This helps maintain a clean aesthetic without visible cables disrupting the visual experience of exhibits. In addition, modular raised floors can be adapted for different exhibition layouts, offering curators the ability to modify setups without permanent alterations to the structure.

Retail spaces, particularly large department stores, also benefit from raised floors by enabling the seamless integration of power and data connections for cash registers, point-of-sale systems, and digital signage. This flexibility allows stores to reconfigure checkout counters and display areas without needing extensive rewiring or construction. The ability to quickly adapt to changing trends and consumer behavior is a significant advantage for retail businesses.

Raised flooring systems provide accessibility advantages in environments where individuals with disabilities require mobility accommodations. By concealing utilities beneath the floor, spaces can maintain smooth and unobstructed walking surfaces without hazards such as exposed wires or cable protectors. Additionally, modular raised floors can be designed to incorporate ramps and other accessibility features, ensuring compliance with accessibility regulations.

One of the advantages of raised flooring is its contribution to improved indoor air quality. Many systems integrate underfloor air distribution (UFAD), which delivers conditioned air through floor diffusers rather than traditional overhead ducts. This method reduces the risk of airborne contaminants and improves ventilation efficiency. The ability to direct airflow more precisely also results in better thermal comfort for building occupants.

The ease of maintenance is another major benefit of raised flooring systems. Because the floor panels can be lifted individually, facility managers can quickly access and repair utilities without causing extensive disruption. This is particularly beneficial in environments that require frequent upgrades or troubleshooting, such as IT rooms, broadcast studios, and telecommunications facilities. The reduced need for invasive construction work extends the lifespan of the building and minimizes repair costs.

Raised floors also contribute to energy efficiency by improving airflow and temperature regulation. The space beneath the floor can be utilized for thermal insulation and passive cooling strategies, reducing reliance on energy-intensive air conditioning systems. In combination with underfloor heating solutions, raised floors provide an effective way to maintain comfortable indoor temperatures while optimizing energy consumption.

Seismic resistance is another reason raised flooring systems are favored in certain regions. In areas prone to earthquakes, raised floors can be engineered to absorb vibrations and reduce structural damage. Some designs incorporate flexible pedestals and shock-absorbing materials to enhance resilience against seismic activity, providing an added layer of protection for critical infrastructure such as data centers and emergency response facilities.

The durability and load-bearing capacity of raised floors make them suitable for environments with heavy equipment. Many industrial applications require floors that can support significant weight loads while maintaining stability. High-strength panels made from steel, aluminum, or reinforced concrete are used to ensure the raised floor system can withstand the demands of specialized workspaces such as server rooms, broadcasting studios, and research laboratories.

Aesthetic benefits also play a role in the adoption of raised flooring. With a clean and uncluttered surface, architectural and interior design elements can be more seamlessly integrated. Many modern raised floors offer customizable finishes, including wood, stone, carpet, and vinyl, allowing businesses to maintain a professional and aesthetically pleasing appearance while benefiting from the functional advantages of a raised floor system.

The use of raised flooring extends to historical building preservation, where maintaining the integrity of existing structures is a priority. Instead of modifying original walls and ceilings to install modern utilities, raised floors provide a non-invasive solution for routing cables and HVAC systems. This approach allows heritage buildings to be adapted for contemporary use without compromising their architectural significance.

While the above-described exemplary uses and benefits of raised flooring will be appreciated by those skilled in the art, such flooring also can present a safety hazard when the flooring (or more likely portions of the flooring) are removed so that below-flooring repairs can be made. In that context, using a safety barrier around an opening in a raised floor is crucial to preventing accidental falls, which can lead to serious injuries or fatalities. Raised flooring systems create gaps and access points for maintenance, repairs, or equipment installation, and these openings pose significant hazards if left unprotected. A safety barrier serves as a physical and visual warning, ensuring that workers and other personnel are aware of the danger. Without proper protection, individuals may inadvertently step into an open section, leading to severe consequences such as fractures, head injuries, or even life-threatening falls.

Beyond preventing falls, a safety barrier also acts as a means of restricting unauthorized access to the opening. In many workplaces, not all employees are trained or equipped to handle exposed floor openings safely. Barriers ensure that only authorized and properly trained personnel can access these areas, reducing the risk of inexperienced individuals putting themselves in danger. This is particularly important in high-traffic environments such as data centers, control rooms, and industrial facilities, where multiple teams may be working simultaneously, increasing the likelihood of accidents if the opening is left unguarded.

A properly installed safety barrier enhances compliance with workplace safety regulations and industry standards. Occupational safety organizations, such as OSHA (Occupational Safety and Health Administration), mandate the use of fall protection measures, including guardrails, barriers, or temporary covers, around floor openings. Failing to implement these safety measures can result in hefty fines, legal liabilities, and reputational damage for businesses. Compliance not only ensures worker safety but also helps companies avoid costly penalties and potential lawsuits resulting from workplace injuries.

The use of safety barriers around raised floor openings also minimizes disruptions in the workplace by preventing accidents before they occur. If an employee or contractor were to fall through an unprotected opening, operations might need to be halted for emergency response, medical attention, and subsequent investigations. These disruptions can lead to project delays, increased insurance costs, and lost productivity. By proactively installing barriers, businesses create a safer work environment that allows operations to continue smoothly without unnecessary risks or interruptions.

Safety barriers also play an essential role in protecting equipment and infrastructure. In raised flooring environments such as data centers or control rooms, floor openings often provide access to critical utilities like power cables, cooling systems, and network connections. An unprotected opening increases the risk of tools, equipment, or debris falling into the underfloor space, potentially damaging sensitive components and causing costly repairs or downtime. Barriers help prevent such incidents by ensuring that only controlled access is granted and that accidental drops are minimized.

Implementing safety barriers demonstrates a company's commitment to workplace safety and employee well-being. A strong safety culture not only improves morale but also encourages workers to be more aware of their surroundings and adhere to best practices. When employees see that their safety is a priority, they are more likely to follow protocols and contribute to a safer working environment. Investing in protective measures such as safety barriers fosters a proactive approach to accident prevention, ultimately benefiting both workers and employers by reducing risks and ensuring a secure workspace.

Accordingly, the present invention is directed to an improved safety barrier for use with raised flooring or any other environment or situation where a safety barrier is useful, needed, advised, or mandated. Those skilled in the art will appreciate the features, advantages, and benefits of this improved safety barrier from the following disclosure.

### BRIEF DESCRIPTION OF THE DRAWINGS

The following disclosure may be understood by reference to the description herein taken in conjunction with the accompanying drawings, in which like reference numerals identify like elements. The accompanying drawings, which are incorporated herein and constitute a part of the specification, illustrate one or more exemplary embodiments of the present invention, except where the drawings are indicated to illustrate the prior art. The present invention should not be considered limited to the following drawings. In the drawings:

FIG. 1 is a perspective view of an exemplary embodiment of the safety barrier of the present invention;

FIG. 2A is a front perspective view of an exemplary embodiment of a clamp for the safety barrier of the present invention;

FIG. 2B is a back perspective view of an exemplary embodiment of a clamp for the safety barrier of the present invention;

FIG. 3 is a front view of the clamp shown in FIG. 2A;

FIG. 4 is a back view of the clamp shown in FIG. 2A;

FIG. 5 is a left side view of the clamp shown in FIG. 2A;

FIG. 6 is a right side view of the clamp shown in FIG. 2A;

FIG. 7 is a bottom view of the clamp shown in FIG. 2A;

FIG. 8 is a top view of the clamp shown in FIG. 2A;

FIG. 9 is a an assembly view of the clamp shown in FIG. 2A;

FIG. 10 is an assembly view of an adjustable fastener shown in FIG. 2A;

FIG. 11 is an perspective view of an adjustable fastener shown in FIG. 2A;

FIG. 12 is a front view of an exemplary scaffold leg;

FIG. 13 is a front view of an exemplary scaffold leg anchor;

FIG. 14 is a front view of an exemplary scaffold leg with scaffold leg anchor;

FIG. 15 is a bottom perspective view of the scaffold leg with scaffold leg anchor (from FIG. 14) attached to a floor grate; and

FIG. 16 is a top perspective view of the scaffold leg with scaffold leg anchor (from FIG. 14) attached to a floor grate.

### DETAILED DESCRIPTION

Various features and advantageous details are explained more fully with reference to the non-limiting embodiments that are illustrated in the accompanying drawings and detailed in the description herein. Descriptions of well-known starting materials, processing techniques, components, and equipment are omitted so as not to unnecessarily obscure the invention. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended or implied. To the extent that a term or phrase is intended to have a special meaning, i.e., a meaning other than that understood by skilled artisans, such special definition will be expressly set forth in the specification in a definitional manner that directly and unequivocally provides the special definition for the term or phrase.

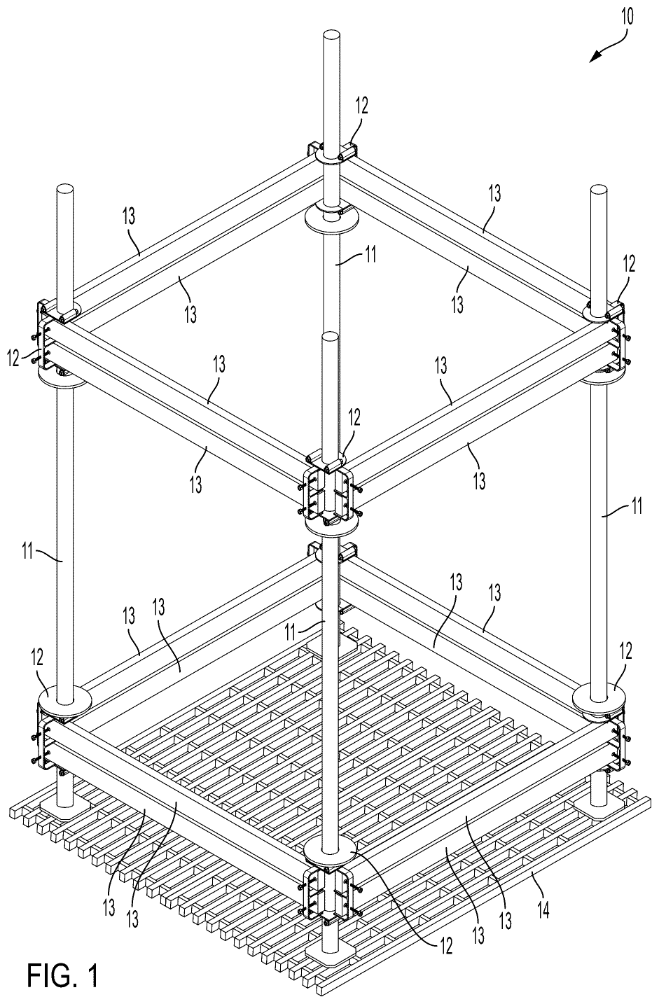

The present exemplary embodiments describe an improved safety barrier. Those skilled in the art will appreciate that other embodiments are contemplated. For example, FIG. 1 is a perspective view 10 of an exemplary embodiment of the safety barrier of the present invention being used. Specifically, FIG. 1 shows an exemplary embodiment of the safety barrier comprising standard scaffold poles (or legs or other supports) 11, each of which (in this embodiment) includes two safety barrier clamps 12 attached thereto. Other embodiments can include less than or more than two safety barrier clamps per scaffold pole or other support. Running through each safety barrier clamp is rail 13. In this embodiment, four rails run through each clamp, but those skilled in the art will appreciate that more or fewer rails may be used. The object is to use enough rails to adequately warn and/or preclude entry into the enclosed area protected by the safety barrier. As FIG. 1 also shows, in this embodiment the safety barrier sits on and is anchored to (as described in more detail below) floor grate 14. Floor grate 14 may reside above solid ground or be part of a raised flooring system. The invention may be used with other flooring systems or no floor at all, i.e., it can simply sit on the ground.

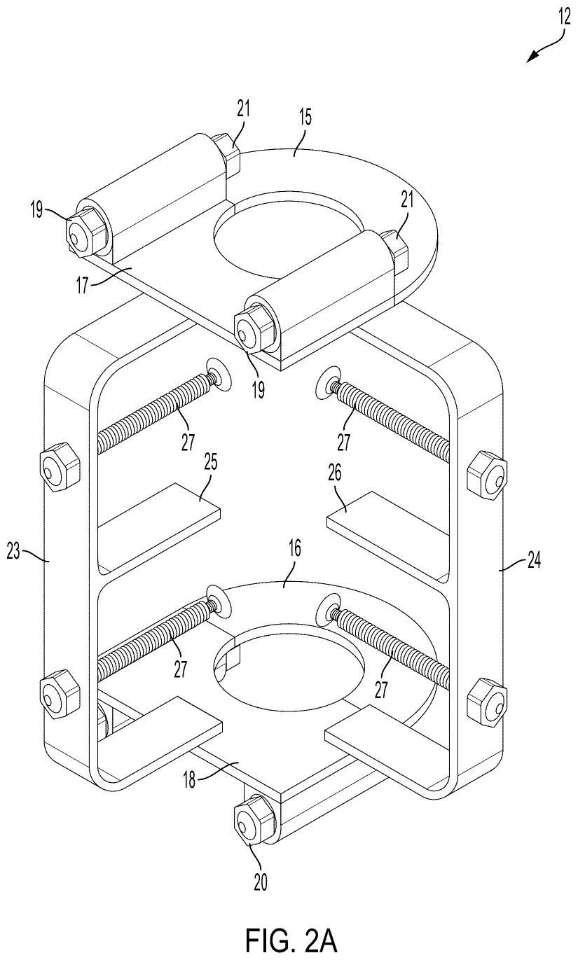

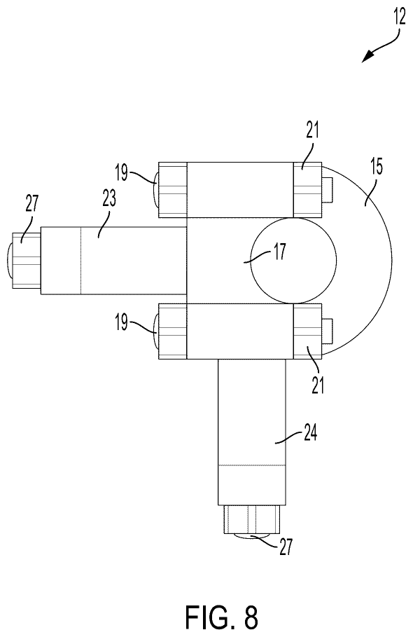

FIG. 2A is a front perspective view of an exemplary embodiment of clamp 12, and FIG. 2B is a back perspective view of the same clamp. As shown, clamp 12 may include upper attachment 15 and lower attachment 16, where upper attachment 15 and lower attachment 16 may be used to attach clamp 12 to scaffold leg 11 (as also shown in FIG. 1). As shown in connection with FIG. 9, upper attachment 15 can be removed and attached to upper portion 17 via upper bolts 19 and upper nuts 21. Likewise, lower attachment 16 can be removed and attached to lower portion 18 via lower bolts 20 and lower nuts 22. Accordingly, to attach safety barrier clamp 12 to scaffold leg 11, upper attachment 15 and lower attachment 16 should be removed from clamp 12 (via bolts 19/20 and corresponding nuts 21/22), then upper and lower portions 17/18 should be centered around a scaffold leg at a desired height on the leg, and then upper attachment 15 should be attached to upper portion 17 (via upper bolts 19 and corresponding upper nuts 21) and lower attachment 16 should be attached to lower portion 18 (via lower bolts 20 and corresponding lower nuts 22). In a preferred embodiment, the diameter of the “hole” or space formed between upper attachment 15 and upper portion 17 and between lower attachment 16 and lower portion 18 preferably is slightly less than the diameter of a standard scaffold leg so that when clamp 12 is attached to scaffold leg 11 it is held in a secure manner that precludes the clamp from sliding up and down the scaffold leg. Those skilled in the art will appreciate that there are other ways to secure clamp 12 to scaffold (or other) leg 11 and that the present invention is not limited to the exemplary embodiment described.

As also shown in FIGS. 2A and 2B, safety barrier clamp 12 may also include first support arm 23 and second support arm 24. These support arms may be connected between upper portion 17 and lower portion 18 as shown. While FIGS. 2A and 2B show the support arms connected at 90 degree angles to upper portion 17 and lower portion 18, it should be appreciated that other angles are anticipated and are within the scope of the present invention since varying the angle will enable the safety barrier 10 to assume different shapes than the square or rectangular shape shown in FIG. 1. Indeed, support arm 23 and/or second support arm 24 could be attached in a fixed or adjustable matter depending on the preference of the user.

First support arm 23 and second support arm 24 also may include first cross bar 25 and/or second cross bar 26, respectively. While the Figures show cross bars 25 and 26 spaced equidistant between the upper and lower portions of the first support arm and the second support arm, respectively, other embodiments are of course possible. The object is simply that there is sufficient room between the cross bar and the upper and/or lower portion of the support arm to allow rail 13 to pass therebetween, as shown in FIG. 1. While FIGS. 2A and 2B show a single first and second cross bar, other embodiments may include more or fewer such cross bars, thereby supporting more or fewer rails 13.

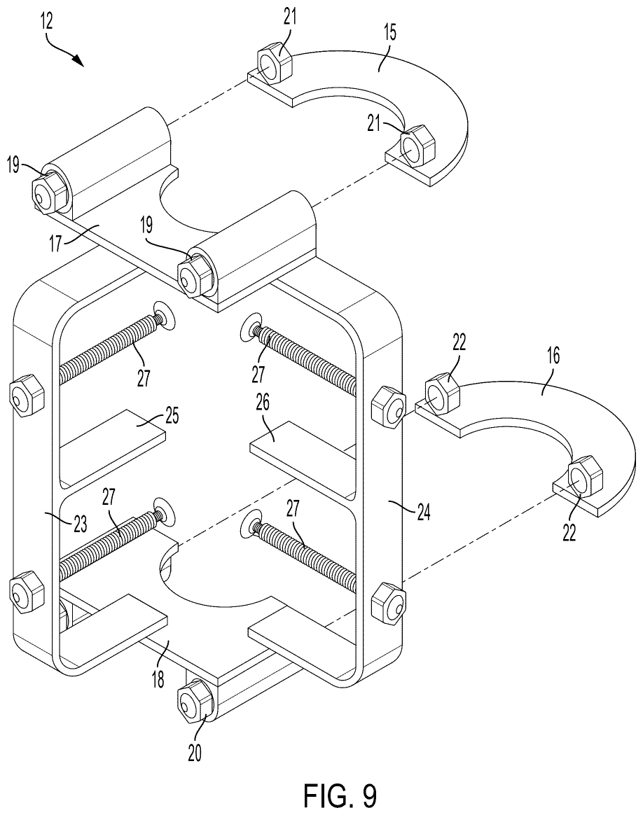

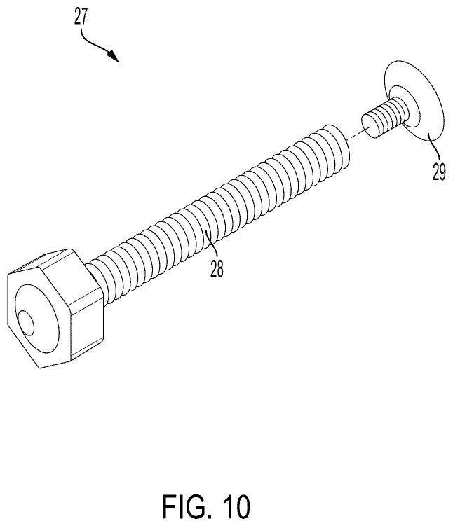

FIGS. 2A and 2B also show that safety barrier clamp 12 may also include one or more adjustable fasteners 27. In this particular embodiment, a separate adjustable fastener 27 is provided: (1) between the upper portion of first support arm 23 and first cross bar 25; (2) between the lower portion of first support arm 23 and first cross bar 25; (3) between the upper portion of second support arm 24 and second cross bar 26; and (4) between the lower portion of second support arm 24 and second cross bar 26. It is not necessary that there be an adjustable fastener for each of the described sections of safety barrier clamp 12. As shown by the threading on the adjustable fasteners, they can be screwed in and out of the first and second support arms to adjust the degree to which rails 13 are secured within clamp 12, i.e., rails 13 will be secured between scaffold legs 11 (on one side) and adjustable fasteners 27 (on the other side) as shown in FIG. 1. In this regard, FIG. 10 is an assembly view of adjustable fastener 27, including bolt 28 and screw-in tip 29. FIG. 11 is a perspective view of adjustable fastener 27. As shown in FIG. 10, screw in tip 29 gives the user the option of changing the type of tip used since different tips will better hold different types of rails 13. While the Figures show adjustable fastener 27 as a “screw-in” type fastener, those skilled in the art will appreciate that other fasteners are possible and that other such possibilities are within the spirit and scope of the present invention.

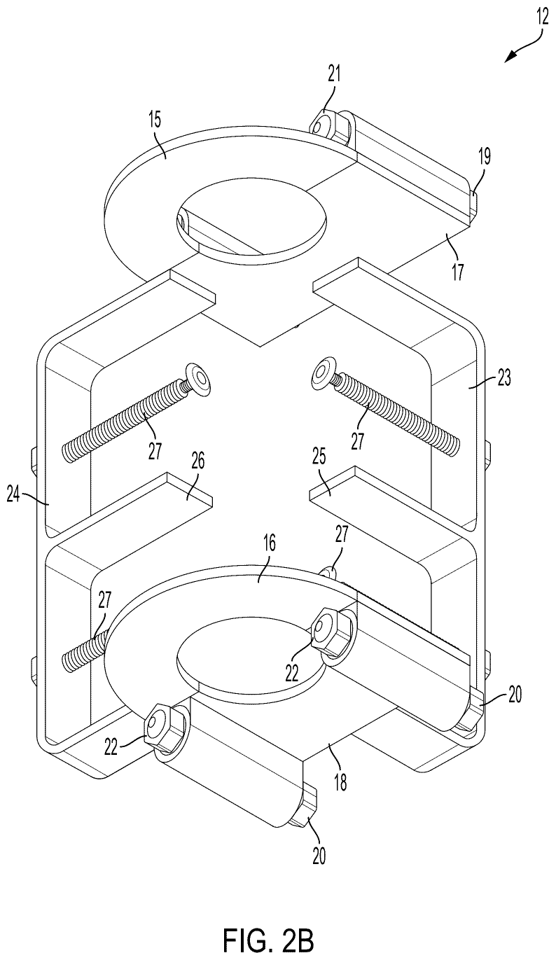

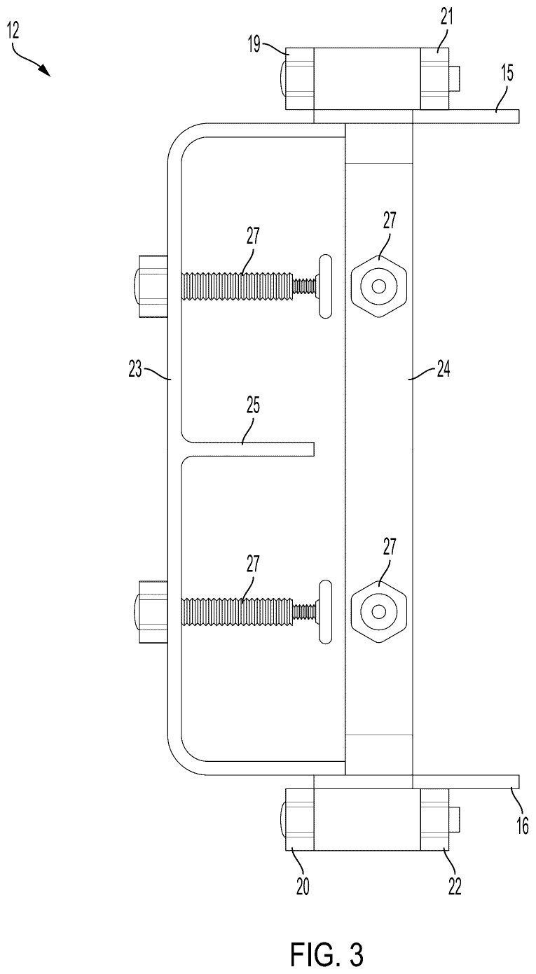

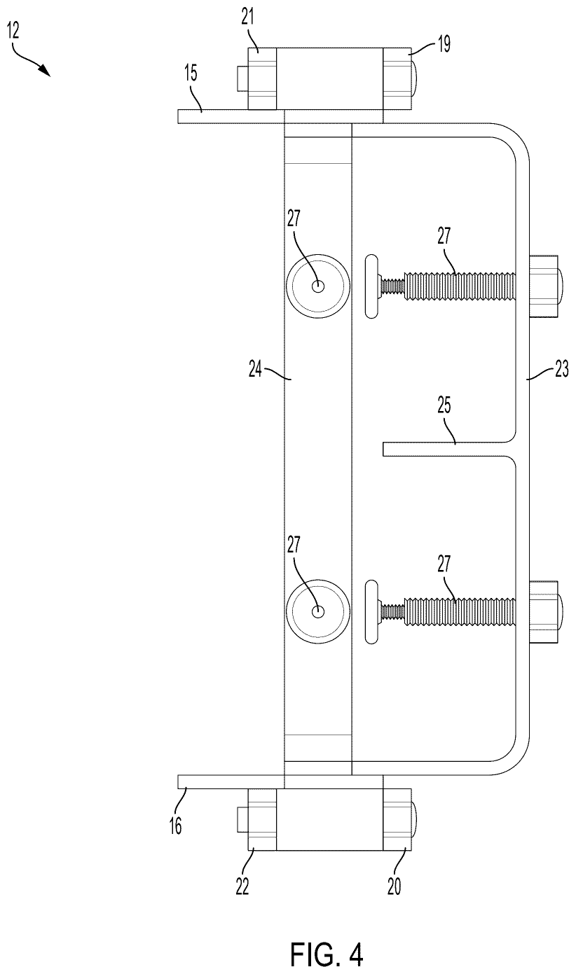

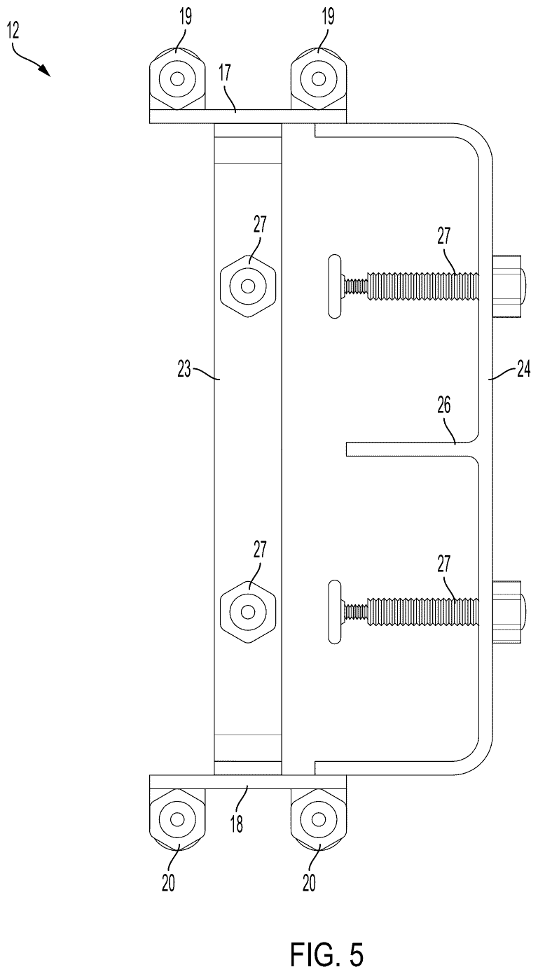

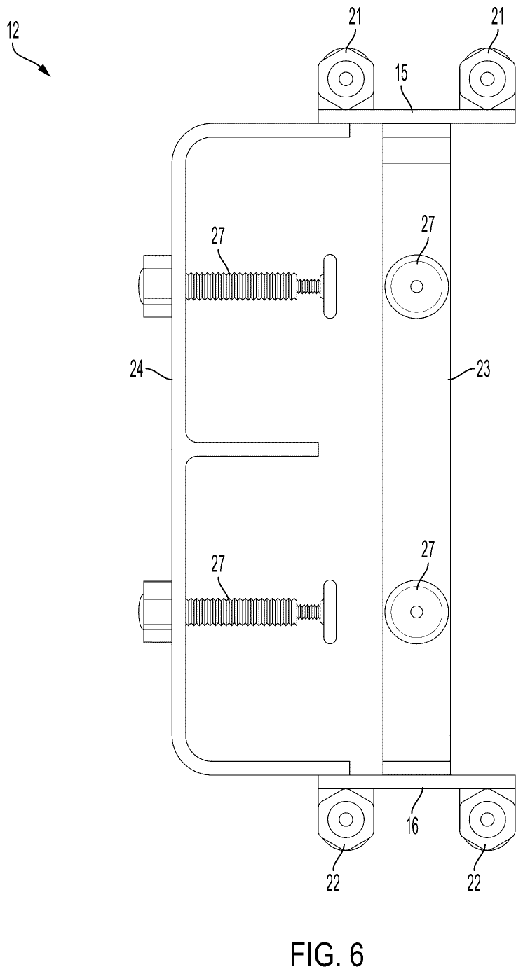

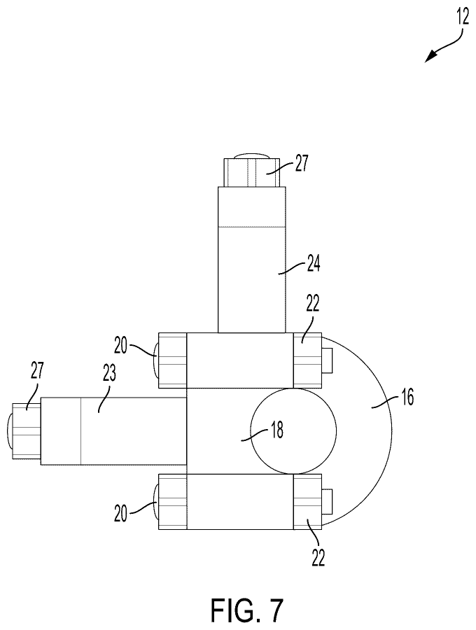

FIG. 4 is a back view of safety barrier clamp 12 shown in FIG. 2A. FIG. 5 is a left side view of safety barrier clamp 12 shown in FIG. 2A. FIG. 6 is a right side view of safety barrier clamp 12 shown in FIG. 2A. FIG. 7 is a bottom view of safety barrier clamp 12 shown in FIG. 2A. FIG. 8 is a top view of safety barrier clamp 12 shown in FIG. 2A. Each of FIGS. 1-11 use like numerical designations to describe like portions of safety barrier clamp 12.

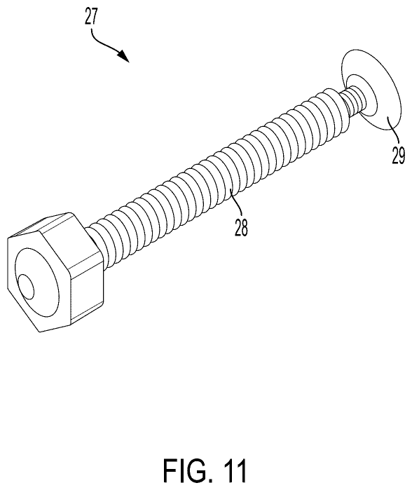

FIG. 12 shows an exemplary embodiment of scaffold leg 11. In this embodiment, of which there are others, scaffold leg 11 may include leg portion 30, leveler 31, and base 32. These are standard components of a scaffold leg and will be well understood by those skilled in the art.

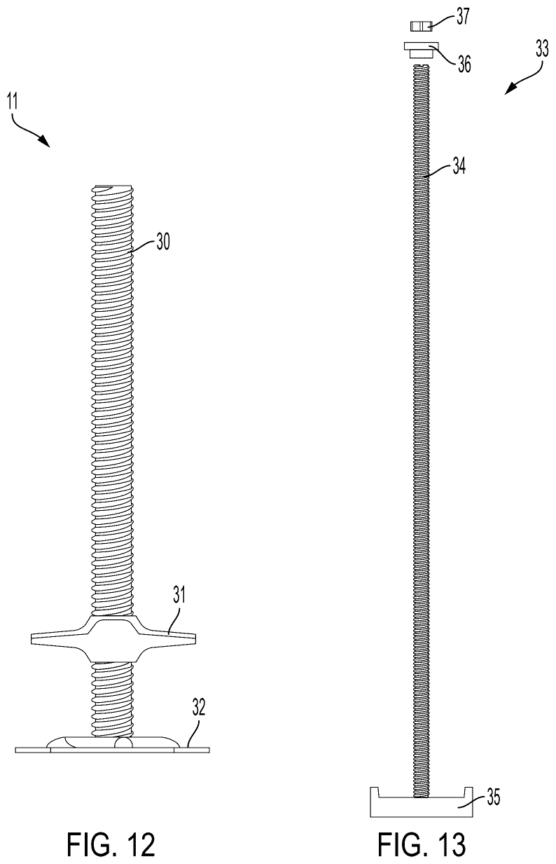

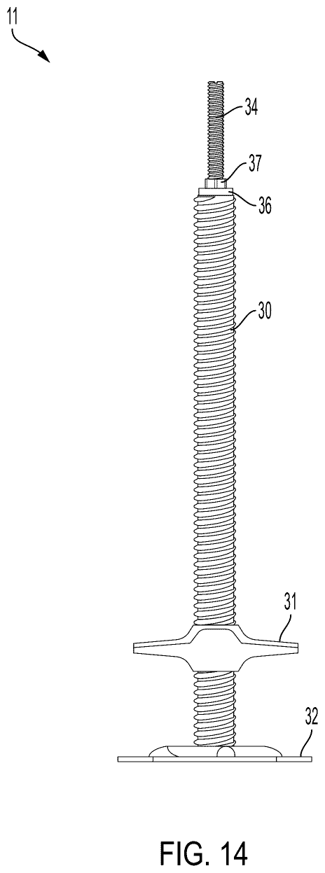

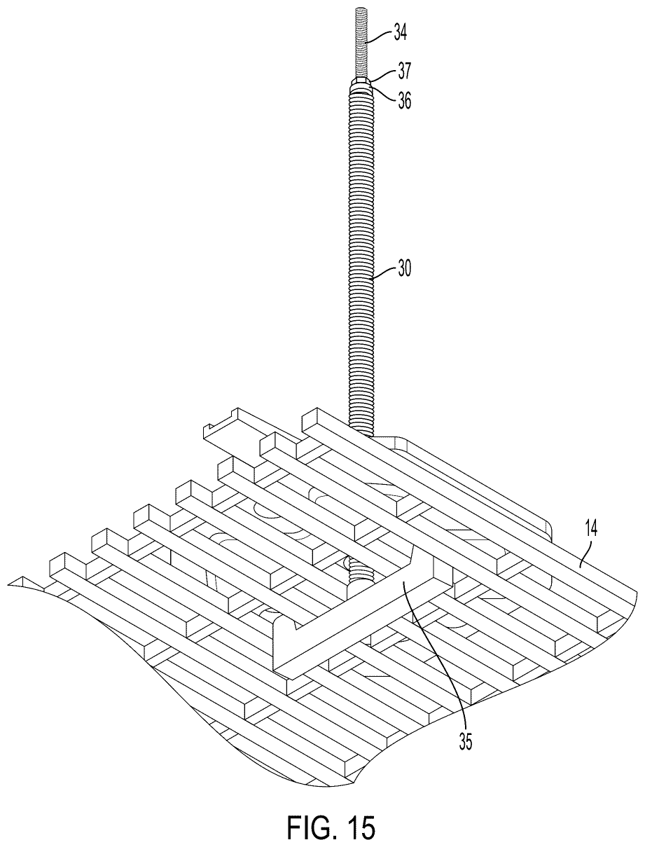

FIG. 13 shows an exemplary embodiment of scaffold leg anchor 33. In this embodiment, of which there are others, scaffold leg anchor 33 may include rod 34, anchor 35, washer 36, and nut 37. As shown in connection with FIGS. 14-16, rod 34 is inserted into a standard bore in leg 30 so that the top of rod 34 extends through a top portion of leg 30 and anchor 35 extends through a bottom portion of leg 30. Anchor 35 is shaped to fit though floor grate 14 when anchor 35 is positioned parallel to the grates in floor grate 14, and then when anchor 35 is turned 90 degrees it latches onto the grates and cannot be removed therefrom while turned as such in that position. (Removing anchor 35 from the floor grate requires that it be turned so that it is substantially parallel to, and centered between, the grates.) To secure anchor 35 in its affixed position relative to floor grate 14, washer 36 is nested into the top of leg 30 and secured in position by nut 37, as shown in FIGS. 13-16. Of note, and as best shown in FIG. 13, in an embodiment washer 36 may include three diameters: (1) a first inside diameter slightly larger than the outside diameter of rod 34 (i.e., so that washer 36 snuggly slides over rod 34); (2) a second inside diameter slightly smaller than the diameter of the bore of leg 30 (i.e., so that washer 36 and rod 34 do not significantly move laterally within the bore of leg 30; and (3) an outside diameter substantially equal to the outside diameter of leg 30 as shown in FIG. 14.

Each leg of safety barrier 10 may include the anchoring system described in connection with FIGS. 12-16. In this exemplary manner, safety barrier 10 may be secured to floor grate 14. This anchoring system is not necessary for situations where safety barrier 10 is not going to be used in a location that has a grated floor and, as such, those skilled in the art will appreciate that the described anchoring system may not be necessary in those circumstances. Likewise, those skilled in the art will appreciate that other anchoring systems are possible and are within the spirit and scope of the present invention.

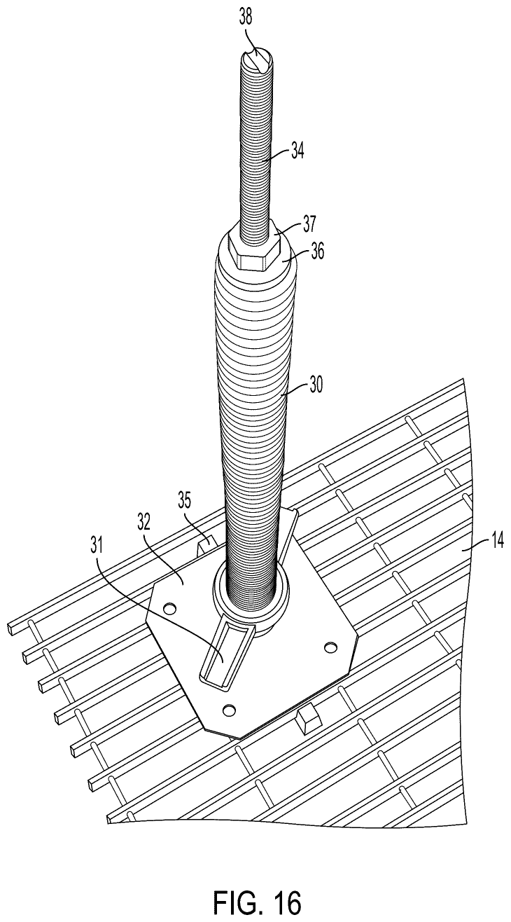

As shown in connection with FIG. 16, rod 34 may include alignment groove 38 on the top of rod 34. As shown, alignment groove 38 is made in the top of rod 34 so that it is substantially parallel (or some other known orientation) to the orientation of anchor 35. This can aid installers of safety barrier 10 to turn rod 34 so that anchor 35 is sure to be oriented at a 90 degree angle to the grates in floor grate 14, thereby ensuring that anchor 35 is in its optimal position to most effectively secure safety barrier 10 to the grated floor. Orienting alignment groove 38 with anchor 35 in a known, predefined manner also can be useful when removing safety barrier 10 from floor grate 14 by indicating when anchor 35 is substantially parallel to the floor grates such that it can be removed therefrom. While this embodiment shows alignment groove 38 on the top of rod 34, those skilled in the art will appreciate that other locations on rod 34 could be used, as well as other alignment methods employed to ensure that anchor 35 is properly positioned for anchoring to and/or removal from a grated floor.

Although the invention(s) is/are described herein with reference to specific embodiments, various modifications and changes can be made without departing from the scope of the present invention(s), as set forth in the claims below. Accordingly, the specification and Figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Accordingly, the protection sought herein is as set forth in the claims below.

1. A safety barrier clamp, comprising:
an upper portion;
a lower portion;
an upper attachment removable from the upper portion and for assisting in at least partially attaching the safety barrier clamp to a support;
a lower attachment removable from the lower portion and for assisting in at least partially attaching the safety barrier clamp to the support;
a first support arm attached between the upper portion and the lower portion;
a second support arm attached between the upper portion and the lower portion;
a first cross bar attached to the first support arm to support a first rail; and
a second cross bar attached to the second support arm to support a second rail.

2. The safety barrier clamp of claim 1 further comprising a first adjustable fastener for securing the first rail against the support and a second adjustable fastener for securing the second rail against the support.

3. The safety barrier clamp of claim 2 wherein the first adjustable fastener is coupled to the first support arm and the second adjustable fastener is coupled to the second support arm.

4. The safety barrier clamp of claim 3 further comprising a third adjustable fastener for securing a third rail against the support and a fourth adjustable fastener for securing a fourth rail against the support.

5. The safety barrier clamp of claim 4 wherein the third adjustable fastener is coupled to the first support arm and the fourth adjustable fastener is coupled to the second support arm.

6. The safety barrier clamp of claim 5 wherein the first support arm is attached to the upper portion and to the lower portion.

7. The safety barrier clamp of claim 6 wherein the second support arm is attached to the upper portion and to the lower portion.

8. The safety barrier clamp of claim 7 wherein the first support arm and the second support arm are oriented at a 90 degree angle to one another.

9. The safety barrier clamp of claim 8 wherein the upper attachment and the lower attachment are vertically aligned.

10. The safety barrier clamp of claim 9 wherein the upper portion and the lower portion are vertically aligned.

11. The safety barrier clamp of claim 10 wherein the first support arm includes an upper end and a lower end, and wherein the second support arm includes an upper end and a lower end.

12. The safety barrier clamp of claim 11 wherein the first cross bar is attached to the first support arm substantially equidistant between the upper end and the lower end of the first support arm, and wherein the second cross bar is attached to the second support arm substantially equidistant between the upper end and the lower end of the second support arm.

13. The safety barrier clamp of claim 12 wherein the first adjustable fastener is coupled to the first support arm substantially equidistant between upper end of the first support arm and the first cross bar, and wherein the second adjustable fastener is coupled to the second support arm substantially equidistant between upper end of the second support arm and the second cross bar.

14. The safety barrier clamp of claim 13 wherein the third adjustable fastener is coupled to the first support arm substantially equidistant between lower end of the first support arm and the first cross bar, and wherein the fourth adjustable fastener is coupled to the second support arm substantially equidistant between lower end of the second support arm and the second cross bar.

15. The safety barrier clamp of claim 14 wherein one or more of the first adjustable fastener, second adjustable fastener, third adjustable fastener, or fourth adjustable fastener has a removable tip.

16. The safety barrier clamp of claim 15 wherein the upper attachment is removable from the upper portion via a bolted connection.

17. The safety barrier clamp of claim 16 wherein the lower attachment is removable from the lower portion via a bolted connection.

18. The safety barrier clamp of claim 17 wherein the first adjustable fastener is coupled to the first support arm via a threaded connection, the second adjustable fastener is coupled to the second support arm via a threaded connection, the third adjustable fastener is coupled to the first support arm via a threaded connection, and the fourth adjustable fastener is coupled to the second support arm via a threaded connection.

19. A safety barrier, comprising:
a plurality of safety barrier clamps, wherein each safety barrier clamp attaches to a support and supports at least one rail,
wherein said support comprises a leg having a bore there-through and a rod at least partially located in said bore,
wherein said rod includes an anchor having an orientation at a first end of the rod and an alignment indicator indicative of said orientation.

20. The safety barrier of claim 19 wherein at least one of the plurality of safety barrier clamps comprises:
an upper portion;
a lower portion;
an upper attachment removable from the upper portion and for assisting in at least partially attaching the safety barrier clamp to the support;
a lower attachment removable from the lower portion and for assisting in at least partially attaching the safety barrier clamp to the support;
a first support arm attached between the upper portion and the lower portion;
a second support arm attached between the upper portion and the lower portion;
a first cross bar attached to the first support arm to support a first rail; and
a second cross bar attached to the second support arm to support a second rail.

21. The safety barrier of claim 20 further comprising a first adjustable fastener for securing the first rail against the support and a second adjustable fastener for securing the second rail against the support.

22. The safety barrier of claim 21 wherein the first adjustable fastener is coupled to the first support arm and the second adjustable fastener is coupled to the second support arm.

23. The safety barrier of claim 22 further comprising a third adjustable fastener for securing a third rail against the support and a fourth adjustable fastener for securing a fourth rail against the support.

24. The safety barrier of claim 23 wherein the third adjustable fastener is coupled to the first support arm and the fourth adjustable fastener is coupled to the second support arm.

25. The safety barrier of claim 24 wherein the first support arm is attached to the upper portion and to the lower portion.

26. The safety barrier of claim 25 wherein the second support arm is attached to the upper portion and to the lower portion.

27. The safety barrier of claim 26 wherein the first support arm and the second support arm are oriented at a 90 degree angle to one another.

28. The safety barrier of claim 27 wherein the upper attachment and the lower attachment are vertically aligned.

29. The safety barrier of claim 28 wherein the upper portion and the lower portion are vertically aligned.

30. The safety barrier of claim 29 wherein the first support arm includes an upper end and a lower end, and wherein the second support arm includes an upper end and a lower end.

31. The safety barrier of claim 30 wherein the first cross bar is attached to the first support arm substantially equidistant between the upper end and the lower end of the first support arm, and wherein the second cross bar is attached to the second support arm substantially equidistant between the upper end and the lower end of the second support arm.

32. The safety barrier of claim 31 wherein the first adjustable fastener is coupled to the first support arm substantially equidistant between upper end of the first support arm and the first cross bar, and wherein the second adjustable fastener is coupled to the second support arm substantially equidistant between upper end of the second support arm and the second cross bar.

33. The safety barrier of claim 32 wherein the third adjustable fastener is coupled to the first support arm substantially equidistant between lower end of the first support arm and the first cross bar, and wherein the fourth adjustable fastener is coupled to the second support arm substantially equidistant between lower end of the second support arm and the second cross bar.

34. The safety barrier of claim 33 wherein one or more of the first adjustable fastener, second adjustable fastener, third adjustable fastener, or fourth adjustable fastener has a removable tip.

35. The safety barrier of claim 19 wherein the alignment indicator is a groove in a second end of the rod.
